(19) United States
(12) Patent Application Publication
(10) Pub. No.: US 2010/0215801 A1
(43) Pub. Date: Aug. 26, 2010

(54) Thin Crust, Flaky Bread Product And Method For Making Same

(75) Inventor: Yayu Sophia Pai, Lombard, IL (US)

Correspondence Address: FITCH EVEN TABIN & FLANNERY, 120 SOUTH LASALLE STREET, SUITE 1600, CHICAGO, IL, 60603-3406, US

(73) Assignee: KRAFT FOODS GLOBAL BRANDS LLC, Northfield, IL (US)

(21) Appl. No.: 12/708,856

(22) Filed: Feb. 19, 2010

Related U.S. Application Data
(60) Provisional application No. 61/154,412, filed on Feb. 22, 2009.

(51) Int. Cl. A21D 10/02; A21D 8/02

(52) U.S. Cl. 426/19; 426/551

(57) ABSTRACT

An improved dough composition is provided which comprises fat flakes, wherein the dough composition can be used to prepare a frozen thin crust bread product. The frozen bread product can be heated in a conventional oven to provide a cooked thin crust bread product having a crispy bottom surface and flaky interior. Methods of preparing the same are also provided.

### CROSS REFERENCE TO RELATED APPLICATION

This application claims the benefit of U.S. Provisional Application No. 61/154,412, filed Feb. 22, 2009, which is hereby incorporated herein by reference in its entirety.

### FIELD OF THE INVENTION

This disclosure relates to an improved thin crust, flaky bread product. More particularly, this disclosure relates to improved dough for making a thin crust pizza product having a crispy bottom surface (i.e., crust) and a flaky interior and a method for making the same. The dough is especially useful for preparing a fully baked or par baked thin crust pizza product with various toppings which can then be prepared in an oven from the frozen state.

### BACKGROUND

Convenience foods (i.e., products which require a minimum amount of consumer preparation and are quick to prepare) are in high demand to accommodate today's busy lifestyles. Examples range from cheese and cracker snacks and refrigerated bagels to frozen dinners. Typically, such products will be eaten as packaged or after a brief heating period in a microwave or conventional oven.

Baked bread products are normally available as freshly prepared products that are intended to be consumed within a relatively short time period or as frozen products which can be stored in the frozen state for relatively long periods of time and then thawed for consumption. Examples of such frozen bread products include frozen pizzas and flatbreads which are then heated in a conventional or microwave oven. Today's standards for reheatable frozen bread products, such as pizza crusts and flatbreads, are high. The marketplace desires, if not expects, reheatable frozen bread products that rival bread products made in a conventional or masonry oven in both texture and taste. Attempts to prepare thin crust, conventionally-sized frozen bread products having toppings have generally not been successful. The problems associated with frozen thin crust products include, for example, (1) moisture migration from the sauce or toppings into the crust, thus resulting in the cooked bread product having less than the desired amount of crispiness; (2) crust that is too thin to support the weight of the toppings; (3) lack of flavor and pleasant mouthfeel characteristic of thicker crust products; and (4) unacceptably chewy texture upon reheating.

Thus, there remains a need for fully baked or par baked frozen bread products which can be cooked in an oven to provide a thin crust bread product having desirable flavor and texture. This disclosure provides a dough composition which, upon heating in an oven, provides a thin crust baked bread product having a crispy bottom surface and a flaky texture. These and other advantages will be apparent upon consideration of the present specification.

### SUMMARY

This disclosure relates to frozen fully baked or par baked thin crust bread products which, when heated in an oven, have a desirable crispy bottom surface while also providing a flaky interior. Generally the bread products of the present invention are generally of the flatbread or pizza crust type and can be prepared with or without toppings. The bread products described herein have a crispy bottom surface that is more “cracker-like” and rigid than conventional thin crust bread products, which typically have a chewy and flexible crust. Advantageously, the bread product described herein has a crispiness and rigidity sufficient to support the weight of conventional pizza toppings after baking whereas conventional thin crust bread products have a weak crust unable to support the weight of conventional pizza toppings. The bread products described herein have a crispy bottom surface and a flaky interior having an appearance similar to that of a layered dough product produced with a conventional lamination process. Laminated bread products of the art have continuous layers of fat and dough, whereas the bread products of the invention have discontinuous fat layers, upon baking, which provide the desired flaky interior. It was surprisingly found that a flaky texture could be achieved in a thin crust bread formulation, i.e., about 1 to about 10 mm thick, preferably about 1 to about 5 mm thick, and most preferably about 2 to about 4 mm thick, while also providing a crispy bottom surface and the desired rigidity.

Preferably, the frozen bread product described herein is heated in an oven to provide a crispy bottom crust with flaky interior. Preferably the frozen bread product will have one or more toppings on the upper exterior surface of the bread product. The toppings can be, and preferably are, placed on the upper exterior surface during manufacture and are frozen in place on the bread product so that the consumer can simply open the package, place it in an oven, and prepare the final product without additional steps. The frozen bread product can also be supplied without toppings; consumers can then prepare the bread product with or without toppings as they desire. For purposes herein, “bread” product, “flatbread-type bread” products, or bread products of the “flatbread type” refer to fully-baked or par-baked thin bread products having a thickness of less than about 10 mm, such as, for example, flatbread, pizza crust, and the like.

For purposes herein, “bottom surface” or “bottom exterior surface” refers to the surface of the bread product which is in contact with an oven rack when cooked in a conventional oven. Likewise, the “top surface” or “top exterior surface” is opposite the bottom surface and can receive the desired topping or toppings. And the “interior portion” refers to the bread product between the top and bottom surfaces and essentially defines the thickness of the bread product. Of course, the bread product may have an outside rim which may be thicker than the thickness of the bread product.

The dough formulation described herein provides a bread product, preferably a thin pizza crust, having a crispy bottom surface and a flaky interior upon cooking in a conventional oven. Preferably, this pizza crust also has a crispy rim around the outer circumference or the “flat” dimension of the crust. The bottom surface of the bread product of the invention is more “cracker-like” and inflexible than conventional thin crust bread products, which typically have a chewy and flexible crust. The rim of the bread product of the invention is at least as crispy as the bottom surface and, generally, is substantially crispier than the bottom surface. For example, the rim will tend to “snap” when bent by the consumer, whereas the bottom surface will generally break more like a cracker without the “snap”.

The dough contains, in baker's percentages, 100 percent dough, about 55 to about 70 percent water, about 0.5 to about 8 percent leavening agent, 0.25 to about 1.5 percent mono- and/or di-glycerides, about 0.5 to about 8 percent oil, and about 4 to about 15 percent fat flakes wherein the dough contains about 9 to about 12 percent protein, wherein the leavening agent comprises yeast, encapsulated chemical leavening base, and leavening acid, and wherein the fat flakes have a thickness of about 0.5 to about 4 mm, although flakes having a smaller thickness (e.g., about 0.5 to about 1.5 mm) should be used for bread products having a thickness of less than about 4 mm. Preferably, the leavening agent comprises about 0.5 to about 5 percent compressed yeast, 0.1 to about 2 percent encapsulated chemical leavening base, and 0.5 to about 1 percent leavening acid. The dough can be formed into the desired shape to form a thin crust type product wherein the flat flakes are uniformly distributed throughout the formed dough product.

It has surprisingly been found that the dough product of the above formulation provides a fully baked or par baked thin crust bread product having a flakier crust as compared to conventional thin crust bread products. The thin crust bread product has a layered structure similar to that of laminated dough products but without the time and expense involved with lamination. It is believed that the layered texture of the bread products described herein is attributable, at least in part, to the inclusion of generally planar fat flakes (i.e., shortening flakes) of a particular size, thickness, firmness, and solid fat content at 80° F. The solid fat content of the fat flakes affects how easily the flakes are damaged during mixing (e.g., lose their “flake” shape, melt, break up, disintegrate, or the like). Generally, fat flakes having lower solid fat content are more delicate and require lower mixing speeds, shorter mixing times, and/or lower dough temperatures during mixing to reduce damage to and/or melting of the fat flakes. Therefore, the mixing speed, the mixing time, and/or dough temperature during mixing should be selected in view of the solid fat content of the fat flakes and the starting size of the fat flakes and in view of the target size of the fat flakes after mixing and before baking.

Specifically, the fat flakes are selected so as to provide a desired melting profile during fully baking or par baking the product. The flat flakes are distributed throughout and non-continuously within the dough. When the individual fat flakes melt during the initial baking, the flakes melt slowly to provide localized areas of melted fat which is absorbed into adjacent dough; it is thought that this localized absorbed melted fat helps form the laminated type structure by preventing the dough on either side of the flat dimension of the fat flake from adhering to each other. This results in a desirable layered structure of melted fat and dough which provides the flaky texture upon baking. The flaky texture would not be achieved if the fat flakes melted during mixing (e.g., due to low SFC at 80° F.) or were otherwise in liquid form prior to baking or immediately upon baking (e.g., due to small particle size) such that the liquid fat was generally homogenously distributed in the dough. Such homogenous distribution of the melted fat results in denser and chewier bread products that do not have the desired flaky or layered texture.

Preferably, the fat flakes used herein are relatively firm solids at 80° F. (e.g., as determined by the solid fat content (“SFC”) and a pressure test). The fat flakes should have a solid fat content of about 45 to about 65 percent at 80° F., preferably about 50 to about 60 percent, and most preferably 55 percent. The fat flakes are also subjected to a pressure test to determine suitability for use in the formulation. Generally, the pressure test is performed by holding and squeezing the flake between the thumb and index finger with gentle pressure (e.g., slightly more pressure than is needed to prevent dropping the flake) for about 5 to about 10 seconds. Flakes with suitable firmness soften slightly but generally maintain the flake shape upon application of such gentle pressure.

The fat flakes have a generally flat, planar shape with a thickness of about 0.5 to about 4 mm. The thickness of the flakes should be less than the thickness of the bread product. Flakes of different thicknesses can be used depending on the desired thickness of the bread product. For example, for a crust having a thickness of about 5 mm, the fat flakes can range in thickness of about 0.5 to about 4 mm, while thinner fat flakes, such as about 0.5 to about 1.5 mm thick, should be used for a bread product having a crust thickness of about 3 mm. Although not critical, the length and/or width of the fat flakes after mixing is generally about 2 mm to about 20 mm, preferably about 3 to about 7 mm. Longer fat flakes will break during the mixing process. The flat flakes can be regular or irregular in shape so long as the desired thickness is obtained.

As those skilled in the art will realize, the initial size of the fat flakes, firmness of the fat flakes, mixing conditions, and similar parameters can be adjusted to provide the desired fat flake size, distribution, and the like which will provide the desired flaky texture in the baked or par-baked product. Adjustment of such parameters can easily be carried out using appropriate experimental designs or methods using laboratory or pilot plant sized batches and then scaling up to manufacturing plant sized batches.

Suitable leavening agents include yeast (e.g., dry yeast, compressed yeast), encapsulated chemical leavening base (e.g., encapsulated sodium bicarbonate, encapsulated ammonium bicarbonate, encapsulated calcium bicarbonate, and the like), leavening acid (e.g., sodium aluminum phosphate, monocalcium phosphate anhydrous or monohydrate, sodium acid pyrophosphate, sodium aluminum sulfate, monopotassium tartrate, dicalcium phosphate dihydrate, glucono-delta-lactone, and the like), mixtures thereof, and the like. Other organic acids suitable for baking may also be used, if desired, such as fumaric acid, lactic acid, tartaric acid, malic acid, citric acid, and the like. Preferably, a combination of compressed yeast, encapsulated sodium bicarbonate, and sodium aluminum phosphate is used as the leavening agent.

The disclosure also includes methods for making the baked or par-baked bread products using this bread dough for later heating in conventional ovens. One such method comprises (a) mixing dough ingredients comprising, in baker's percentages, 100 percent flour, about 55 to about 70 percent water, about 0.5 to about 8 percent leavening agent, about 0.5 to about 8 percent oil, about 0.25 to about 1.5 percent mono- and/or di-glycerides, and about 4 to about 15 percent fat flakes, wherein the dough contains less than about 12 percent protein, wherein the leavening agent comprises yeast, encapsulated chemical leavening base, and leavening acid, and wherein the fat flakes have a thickness of about 0.5 to about 4 mm; (b) resting the dough, such as for about 5 to about 10 minutes; (c) cutting the dough to the desired weight; (d) proofing the dough, such as at about 80 to about 110° F. for about 20 to about 60 minutes at a relative humidity of about 50 to about 80 percent; (e) pressing to shape the dough; and (f) baking the dough to form a fully baked or par-baked bread product. Of course, the conditions under which the fat flakes are incorporated into the dough should be adjusted so that the appropriately sized fat flakes are contained in the dough prior to the initial baking step. The baked or par-baked bread product may then be topped with one or more toppings, if desired, and frozen. Alternatively, the fully baked or par-baked product may first be frozen, the toppings added, and the total product frozen. Preferably, the flour, mono- and/or di-glycerides, leavening agent, oil, water, and any optional ingredients are mixed together first and then the fat flakes are incorporated therein; this allows more precise control over mixing conditions, and thus the particle size of the fat flakes, within the dough as well as avoiding damaging the fat flakes. Mixing should be controlled so that the fat flakes are of the desired size in the dough and are distributed uniformly through the dough.

If desired, the frozen bread product described herein may include a variety of toppings, such as, but not limited to, meat, cheeses, vegetables, tofu, soy, soy derivatives, sauces, dressings, spreads, gravies, condiments, spices, herbs, flavorings, colorants, and the like, as well as mixtures thereof.

In one preferred form, the bread product is a frozen pizza crust that, when heated in an oven provides a thin pizza crust that can be baked in a conventional oven to provide a thin crust pizza having a crispy bottom surface while the interior of the pizza crust has a layered, flaky texture.

### BRIEF DESCRIPTION OF THE DRAWINGS

FIG. 1 provides a side view of a bread product after fully baking or par-baking with a topping on the upper bread surface.

FIG. 2(A) illustrates the rigidity of a slice of the thin pizza crust of the invention as compared to a slice of conventional thin crust pizza, shown in FIG. 2(B), when held by hand for consuming.

FIG. 3 provides a general flow chart illustrating a general method for the preparation of a fully assembled frozen flatbread product of the invention.

FIG. 4 provides a side view of the dough after being formed into the desired shape (i.e., thin crust) with the fat flakes distributed throughout the thickness of the crust prior to fully baking or par-baking.

Those skilled in the art will appreciate that elements in the figures are illustrated for simplicity and clarity and are not drawn to scale. For example, the dimensions and/or relative positioning of some of the elements in the figures may be exaggerated relative to other elements to help to improve understanding of various embodiments of the invention. Also, common but well-understood elements that are useful or necessary in a commercially feasible embodiment are often not depicted in order to facilitate a less obstructed view of these various embodiments of the invention. It will also be understood that the terms and expressions used herein have the ordinary meaning as is accorded to such terms and expressions with respect to their corresponding respective areas of inquiry and study except where specific meanings have otherwise been set forth herein.

### DETAILED DESCRIPTION

This disclosure relates to an improved dough and frozen bread product, preferably a thin flatbread product, such as a pizza crust, flatbread, and the like. Such bread products, when heated in a conventional oven, have a crispy bottom surface while the interior of the bread product has a desirable layered, flaky texture. The bread products described herein have a crispy bottom surface and a flaky interior having an appearance similar to that of a layered dough product produced with a conventional lamination process. Laminated bread products of the art have continuous layers of fat and dough, whereas the bread products of the invention have discontinuous fat layers, upon baking, which provide the desired flaky interior. The bread products described herein have a crispy bottom surface that is more “cracker-like” and inflexible than conventional thin crust bread products, which typically have a chewy and flexible crust. Advantageously, the bread product described herein has a crispiness and rigidity sufficient to support the weight of conventional pizza toppings after baking whereas conventional bread products have a weak crust unable to support the weight of conventional pizza toppings. It was surprisingly found that a flaky texture could be achieved in a thin crust bread formulation, i.e., about 1 to about 10 mm thick, preferably about 1 to about 5 mm thick, and most preferably about 2 to about 4 mm thick, while also providing a crispy bottom surface and the desired rigidity. The flaky texture provided in the bread products described herein is very desirable to consumers and has not been achieved in thin crust bread products prior to the invention described herein. If desired, the bread product may include toppings on the upper surface. This disclosure further relates to method of making the dough and frozen bread products.

For purposes herein, “bottom surface” or “bottom exterior surface” refers to the surface of the bread product which is in contact with an oven rack when cooked in a conventional oven. Likewise, the “top surface” or “top exterior surface” is opposite the bottom surface and can receive the desired topping or toppings. And the “interior portion” refers to the bread product between the top and bottom surfaces and essentially defines the thickness of the bread product. Of course, the bread product may have an outside rim which may be thicker than the thickness of the bread product.

The bread formulations of this disclosure are designed to provide good organoleptic properties and a crisp bottom layer while the interior of the bread product has a flaky texture after baking in a conventional oven by the consumer. Thus, the bread formulations provided herein have better organoleptic properties as compared to similar products prepared with conventional dough formulations, including conventional dough formulations used in thin bread products currently available in the marketplace. Although the dough formulations described herein are especially designed for use in thin pizza crusts, the dough formulations can be used to advantage in other bread products, including those intended to be heated in conventional ovens, such as flatbread products.

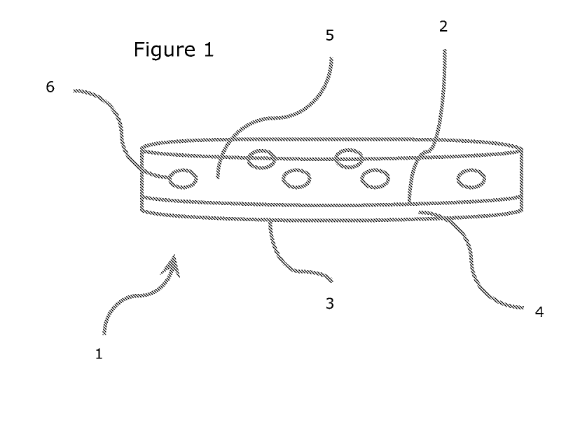

FIG. 1 illustrates a fully assembled frozen bread product 1 having an upper surface 2, a bottom surface or base 3, an interior portion 4, and topping 5. Topping 5 may be provided on the upper surface 2 of the bread product 1. In one aspect, the bread product 1 may include a topping 5, which may include, if desired, meat or vegetables in the form of chunks, lumps, or diced shapes 6. The topping may be substantially coextensive with the upper surface 2 (as illustrated) but is not required. Alternatively, the bread product may have a rim, which preferably has a greater thickness than the bottom surface or base of the bread product. In a preferred aspect, the bread product is cooked in an oven. The bottom surface 3 becomes crispy during final heating. The interior portion has a layered, flaky texture not previously achievable in thin bread products, e.g., bread products having a thickness of about 1 to about 10 mm, preferably about 1 to about 5 mm, more preferably about 2 to about 4 mm.

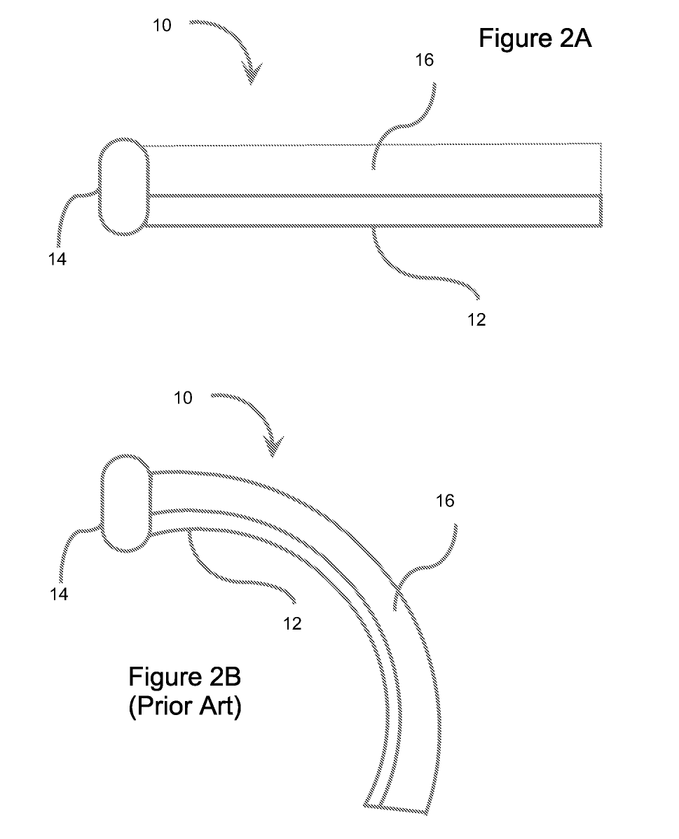

Moreover, the crispy, but not hard or tough, bottom crust of the bread product provides sufficient support to withstand the weight of conventional pizza toppings. As shown in FIG. 2(A), the bread product of the invention, shown as a pizza crust 10 with bottom surface 12 (e.g., base), rim 14, and toppings 16 on bottom surface 12, can be picked by rim 14 of the crust without the bottom surface of the pizza bending or breaking under the weight of the toppings 16. FIG. 2(B) depicts a conventional thin crust pizza, the crust of which is unable to support the weight of the toppings. The bottom surface of the bread product of the invention is more “cracker-like” and inflexible than conventional thin crust bread products, which typically have a chewy and flexible crust. The rim of the bread product of the invention is at least as crispy as the bottom surface and, generally, is substantially crispier than the bottom surface. For example, the rim will tend to “snap” when bent by the consumer, whereas the bottom surface will generally break more like a cracker without the “snap”.

Dough Formulation. The following descriptions refer to preparation and use of bread dough for purposes of the provided non-limiting illustrations, but it will be appreciated that the concepts of the disclosure are considered to be generally applicable to a variety of fully-baked or par-baked thin bread products, including flatbread, pizza crust, and the like.

The bread dough described herein comprises a unique formulation which provides the desirable flaky interior and crispy bottom surface upon heating in a conventional oven. The bread dough comprises a leavened mixture comprising a major portion of flour and water and a minor portion of fat flakes, oil, mono- and/or di-glycerides. The bread dough may be yeast and/or chemically leavened, although the leavening agent comprises both compressed yeast and chemical leavening agents (i.e., encapsulated chemical leavening base and leavening acid).

It should be noted that the percentages used to describe the dough product are baker's percentages, which are weight percentages based on the weight of flour used in a specific recipe (generally per 100 pounds of flour). For example, for 100 pounds of flour in a recipe, 55 percent water and 0.5 percent compressed yeast would mean the addition of 55 pounds of water and 0.5 pounds of water to 100 pounds of flour. Of course, such baker's percentages do not add up to 100 percent. Conventional percentages can be calculated from baker's percentages by normalizing to 10 percent.

An illustrative and preferred recipe (in baker's percentages) for dough prepared according to an embodiment of the invention is provided in the table below.

| | Illustrative Recipe | Preferred Recipe |
|---|---|---|
| Ingredient | (% flour basis) | (% flour basis) |
| Flour | 100 | 100 |
| Compressed yeast | 0.5-5 | 2-3 |
| Encapsulated chemical | 0.1-2 | 0.1-0.5 |
| leavening base | | |
| Leavening acid | 0.1-1 | 0.1-0.5 |
| Salt | 0-4 | 1-3 |
| Sweetener | 0-6 | 0.5-1.5 |
| Mono- and di-glycerides | 0.25-1.5 | 0.25-1.0 |
| Fat flakes | 4-15 | 5-12 |
| Water | 55-70 | 58-60 |
| Oil | 0.5-8 | 3-5 |

The fat flakes (i.e., shortening flakes) useful herein have a generally flat, planar shape. Fat flakes used in the present invention can be regularly shaped particles or irregularly shaped particles; the actual shape of these fat flakes does not appear to be especially important. However, many other factors are involved in successfully incorporating fat flakes into the dough formulation, including the size of the fat flakes, the solid fat content of the fat flakes, the temperature of the dough, the mixing speed, and mixing time. The solid fat content of the fat flakes affects how easily the flakes are damaged during mixing (e.g., lose their “flake” shape, melt, break up, disintegrate, or the like). Generally, fat flakes having lower solid fat content are more delicate and require lower mixing speeds, shorter mixing times, and/or lower dough temperatures during mixing to reduce damage to and/or melting of the fat flakes. Therefore, the mixing speed, the mixing time, and/or dough temperature during mixing should be selected in view of the solid fat content of the fat flakes and the starting size of the fat flakes and in view of the target size of the fat flakes after mixing and before baking.

Preferably, the fat flakes used herein are relatively firm solids at 80° F. (e.g., as determined by the solid fat content (“SFC”) and a pressure test). The fat flakes should have a solid fat content of about 45 to about 65 percent at 80° F., preferably about 50 to about 60 percent, and most preferably 55 percent. The fat flakes are also subjected to a pressure test to determine suitability for use in the formulation. Generally, the pressure test is performed by holding and squeezing the flake between the thumb and index finger with gentle pressure (e.g., slightly more pressure than is needed to prevent dropping the flake) for about 5 to about 10 seconds. Flakes with suitable firmness soften slightly but generally retain the flake shape upon application of such gentle pressure. Flakes that are unsuitable impart a sticky residue to the fingers and deform under such pressure. Fat flakes in the form of relatively firm solids at 80° F., as described above, generally provide bread products having a flakier texture than bread products made with softer fat flakes (i.e., have a solid fat content of less than about 45 percent at 80° F.).

The flat flakes have a generally flat, planar shape with a thickness of about 0.5 to about 4 mm. The thickness of the flakes should be less than the thickness of the bread product. Flakes of different thicknesses can be used depending on the desired thickness of the bread product. For example, for a crust having a thickness of about 5 mm, the fat flakes can range in thickness of about 0.5 to about 4 mm, while thinner fat flakes, such as about 0.5 to about 1.5 mm thick, should be used for a bread product having a crust of about 3 mm.

The fat flakes can be regular or irregular in shape so long as the desired thickness is obtained. Larger fat flakes may be added to the dough so long as the size of the fat flakes is reduced during mixing or the fat flakes distributed within the dough are of a size that allows formation of a layered structure within the fully baked or par baked bread products of this invention. Although not critical, the length and/or width of the fat flakes after mixing is generally about 2 mm to about 20 mm, preferably about 3 to about 7 mm. For example, if the particular fat flakes selected are of the size desired after mixing, the dough temperature can be selected so as to prevent melting of the fat flakes during mixing and/or the mixing speed and time can be selected so as to substantially reduce the amount of damage caused to the fat flakes. Alternatively, if the particular fat flakes selected are larger than the size desired after mixing, more intense mixing conditions and/or higher temperatures of the dough may be necessary to break-up and reduce the size of the fat flakes. Fat flakes that are too small or melt during mixing provide a dough mass having a generally homogenously distributed liquid fat content. Instead, the dough should include fat flakes dispersed within the dough which melt during baking to provide the desired flaky texture after baking. As noted above, initial size and firmness of the fat flakes and the mixing conditions can be adjusted to provide a dough having properly sized fat flakes uniformly distributed within the dough, which can then be baked or par baked to provide a bread product with an interior portion having a layered, flaky texture.

Suitable leavening agents include yeast (e.g., dry yeast, compressed yeast, cream yeast), encapsulated chemical leavening base (e.g., encapsulated sodium bicarbonate, encapsulated ammonium bicarbonate, encapsulated calcium bicarbonate), leavening acid (e.g., sodium aluminum phosphate, monocalcium phosphate anhydrous or monohydrate, sodium acid pyrophosphate, sodium aluminum sulfate, monopotassium tartrate, dicalcium phosphate dihydrate, glucono-delta-lactone), mixtures thereof, and the like. Other organics acids suitable for baking may also be used, such as fumaric acid, lactic acid, tartaric acid, malic acid, citric acid, and the like. Preferably, a combination of compressed yeast, encapsulated chemical leavening base, and leavening acid is used. More preferably, compressed yeast, encapsulated sodium bicarbonate, and sodium aluminum phosphate are used as the leavening agent. It was surprisingly found that using a leavening agent comprising compressed yeast, encapsulated chemical leavening base, and acid leavening agent provided a bread product, which upon baking in a conventional oven, has a crispier outer layer than a similar bread product where either the compressed yeast or encapsulated chemical leavening base (with leavening acid) was used without the other. Generally, a bread product made with compressed yeast but without chemical leavening agent provides a slightly denser product. A bread product made with encapsulated chemical leavening base and leavening acid but without compressed yeast lacks desired flavor. Therefore, it is preferable that the leavening agent comprises a combination of compressed yeast, encapsulated chemical leavening base, and compressed yeast, such as about 0.5 to about 5 percent compressed yeast, 0.1 to about 2 percent chemical leavening agent, and about 0.1 to about 1 percent leavening acid are used; preferably about 2 to about 3 percent compressed yeast, about 0.1 to about 0.5 percent chemical leavening base, and about 0.1 to about 0.5 percent leavening acid are used. Dry yeast may be substituted for the compressed yeast. If dry yeast is used, the baker's percentage or weight is adjusted to account for the water content of the compressed yeast; likewise, the amount of water added may be increased to account for the water content of the compressed yeast.

Exemplary of the flour component or farinaceous materials which may be used, for example, are whole grain or refined wheat flour. Hard or soft wheat flours, red or white wheat flours, winter or spring, and blends thereof, all purpose flours, and so forth may be used. The flour may be bleached or unbleached. Wheat flour or mixtures of wheat flour with other grain flours are preferred. Low protein flours (e.g., about 9 to about 10 percent protein) may also be used if desired. Flours having a protein content of less than about 9 percent generally do not provide the functionality (e.g., elasticity) desired in the resulting dough product. Generally, it is preferable to use flour having about 9 to about 12 percent protein, preferably about 10 to about 11 percent protein. Flour having a high protein content (e.g., more than about 12 percent protein) should generally not be used as the high protein content contributes to an undesirable chewy texture in the final bread product. Non-wheat flours, such as soy flour, rice flour, corn flour, and the like, may be used, if desired, in combination with wheat flour to dilute the protein content of the wheat flour.

The mono- and/or di-glycerides included are effective to interfere with the gluten network in the dough. Generally, gluten is a protein substance obtained from wheat flour which imparts cohesiveness and elasticity to dough. Gluten also contributes to the chewiness of bread products. Therefore, thin bread products prepared with mono- and/or di-glycerides have a less chewy texture than those thin bread products prepared without mono- and/or di-glycerides. The amount of mono- and/or di-glycerides required for the dough product is proportional to the protein content of the flour. For flour having a protein content of about 9 to about 12 percent, about 0.25 to about 1.5 percent mono- and/or di-glycerides is used, preferably less than about 1 percent mono- and/or di-glycerides.

The bread dough also may contain minor amounts of other functional and flavoring additives commonly used in bread dough, such as oil, protein source, sweetener, preservative, emulsifier, salt, dough conditioners, chemical leavening agent, herbs, seasonings, spices, and the like, as long as the additional ingredients do not adversely affect formation of the product with the crispy bottom and flaky interior. If desired, the dough can be fortified with macronutrients and/or micronutrients, such as iron preparations, bioavailable calcium sources, vitamins, minerals, amino acids, and other nutraceuticals. Vitamin and vitamin-like nutritional fortification can be obtained using Vitamin C, Vitamin E sources, Vitamin D sources, beta carotene sources, and so forth.

Suitable oils include vegetable oils, shortening, hydrogenated oil, and the like. Preferred vegetable oils are corn, canola, olive, sunflower seed, cottonseed and soybean oils, or mixtures thereof, with soybean oil and corn oil being the most preferred. Other edible oils may also be used. A single edible oil or mixtures of such edible oils may be used. The oil may have a butter flavoring agent. Fat substitutes may also be used, if desired. Alternatively, a butter flavoring agent or other flavoring agent may be added to the recipe in an amount known to those skilled in the art or in accordance with the flavor manufacturer's recommendations.

The dough also may include sweeteners. These include sugars such as sucrose, fructose, glucose, high fructose corn syrup, or other sweet mono- or disaccharides commonly used in baking materials. The total sugar solids content of the dough of the present invention may range from 0 up to about 6 percent by weight, depending on the product. For bread dough, the total sugar content generally may range between 0 to about 6 percent by weight, preferably between about 0.5 to about 1.5 percent. All or a portion of the natural sweetener content can be substituted by or augmented with artificial sweetener, normutritive sweetener, high intensity sweetener, sugar alcohol materials, and the like. Of course, if used, the levels of such other sweeteners should be adjusted to provide the desired level of sweetness and, if appropriate (i.e., if corn syrup is used), the level of water may be adjusted to account for water added with the sweetener.

If desired, emulsifiers may be included in effective, emulsifying amounts in the dough of the disclosure. Exemplary emulsifiers which may be used include, mono- and di-glycerides, polyoxyethylene sorbitan fatty acid esters, DATEM (di-acetyl tartaric acid esters of mono- and diglycerides), lecithin, stearoyl lactylates, and mixtures thereof. Exemplary of the polyoxyethylene sorbitan fatty acid esters which may be used are water-soluble polysorbates such as polyoxyethylene (20) sorbitan monostearate (polysorbate 60), polyoxyethylene (20) sorbitan monooleate (polysorbate 80), and mixtures thereof. Examples of natural lecithins which may be used include those derived from plants such as soybean, rapeseed, sunflower, or corn, and those derived from animal sources such as egg yolk. Soybean-oil-derived lecithins are preferred. Exemplary of the stearoyl lactylates are alkali and alkaline-earth stearoyl lactylates such as sodium stearoyl lactylate, calcium stearoyl lactylate, and mixtures thereof. Exemplary amounts of the emulsifier which may be used range up to about 3 percent by weight of the dough.

Since the baked or par baked bread of this invention will generally be distributed in a frozen form, preservatives may not be required. Nevertheless, the dough of the disclosure may include antimycotics or preservatives, such as calcium propionate, potassium sorbate, sorbic acid, sodium benzoate, nisin, and the like, singly or in combinations thereof, if desired. Exemplary amounts may range up to about 1 percent by weight of the dough, to assure microbial shelf-stability.

Flavorings and/or spices may be used in the manufacture of the flatbread dough, if desired. The flavorings may include, for example, olive oil, rosemary, garlic, butter, salt and the like. Other flavorings or combinations of flavorings may be used, if desired.

Optionally, breadcrumbs may be applied to the bottom surface of the dough product before baking. If used, the breadcrumbs are preferably Japanese breadcrumbs (e.g., Panko breadcrumbs), which have an airier texture than Western breadcrumbs. Addition of breadcrumbs to the bottom surface of the dough product can provide additional crispiness to the bottom surface after baking. The breadcrumbs can be added to the bottom surface using any conventional method, such as, for example, rolling or extruding the dough onto the breadcrumbs.

The bread formulations of this disclosure are designed to provide good organoleptic properties and a crisp bottom layer while the interior of the bread product has a flaky texture after baking in a conventional oven by the consumer. Thus, the bread formulations provided herein have better organoleptic properties as compared to similar products prepared with conventional dough formulations, including conventional dough formulations used in thin bread products currently available in the marketplace. Although the dough formulations described herein are especially designed for use in thin pizza crusts, the dough formulations can be used to advantage in other bread products, including those intended to be heated in conventional ovens, such as flatbreads.

Dough Mixing and Dough Products. The dough formulations of the disclosure can be formed into a useful bread product using a variety of techniques. The dough is mixed, rested, shaped, proofed, and baked before freezing. The bread product may be topped before or after freezing, if desired. The sequence of the other operations is not particularly limited and may be varied. It is important, as noted above, that the initial size and hardness of the fat flakes, as well as the conditions under which they are incorporated into the dough, be adjusted to obtain the desired size and homogenous distribution of the fat flakes in the dough before baking so that the desired textural characteristics are obtained.

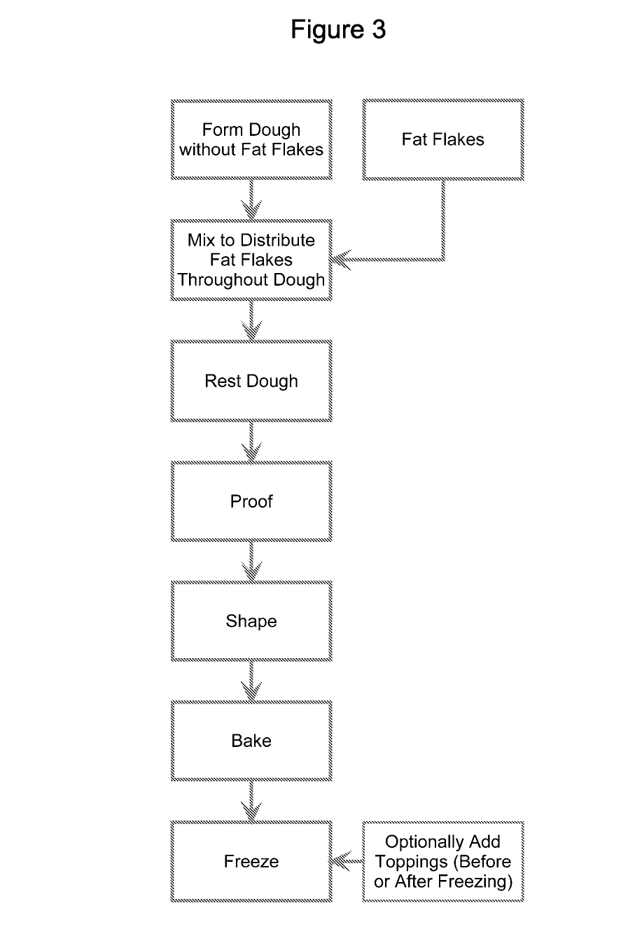

FIG. 3 illustrates a preferred general method of preparing fully assembled frozen bread products of the disclosure. As those skilled in the art will recognize, the order of steps shown in FIG. 3 can be modified if desired; for example, freezing can occur before or after adding a topping. The dough is first prepared by mixing dough ingredients comprising, in baker's percentages, 100 percent flour, about 55 to about 70 percent water, about 0.5 to about 8 percent leavening agent, about 0.25 to about 1.5 percent mono- and/or di-glycerides, and about 4 to about 15 percent fat flakes. Other ingredients may be added if desired. Preferably, the mono- and/or di-glycerides, flour, leavening agent, oil, water, and any optional ingredients are mixed prior to the addition of the fat flakes in order to allow better control of the size and distribution of the fat flakes in the dough.

The fat flakes are added and mixed under conditions to provide the desired size and distribution of the fat flakes in the dough. The mixing speed, the mixing time, and/or dough temperature during mixing should be selected in view of the solid fat content of the fat flakes and the starting size of the fat flakes to achieve the desired size and distribution of the fat flakes after mixing and before baking. For example, if the particular fat flakes selected are close to the size desired after mixing, the dough temperature can be selected so as to prevent melting of the fat flakes during mixing and/or the mixing speed and time can be selected so as not to substantially reduce the size of the fat flakes or otherwise damage them. Alternatively, if the particular fat flakes selected are larger than the size desired after mixing, mixing conditions can be modified to achieve the desired size and distribution of the fat flakes in the dough prior to baking.

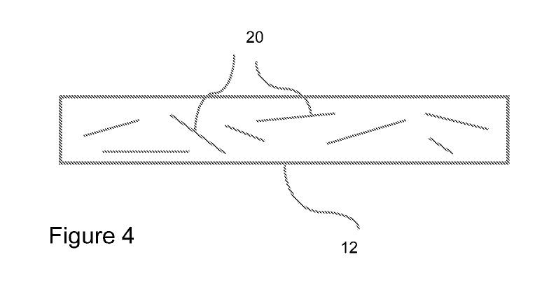

As depicted in FIG. 4, fat flakes 20 are dispersed heterogeneously in dough 12. It has surprisingly been found that the dough product of the above formulation provides a fully baked or par baked thin crust bread product having a flakier crust as compared to conventional thin crust bread products. The thin crust bread product has a layered structure similar to that of laminated dough products but without the time and expense involved with lamination. It is believed that the layered texture of the bread products described herein is attributable, at least in part, to the inclusion of generally planar fat flakes (i.e., shortening flakes) of a particular size, thickness, firmness, and solid fat content at 80° F. Generally, otherwise similar baked products prepared without fat flakes or with a lesser amount of fat flakes are denser with a chewier texture.

The resulting dough mixture is rested for about 5 to about 10 minutes and then, if necessary, cut to the desired weight. The dough is then proofed, such as at about 80 to about 110° F. for about 20 to about 60 minutes at a relative humidity of about 50 to about 80 percent. The proofed dough is then shaped, such as by pressing, to desired thickness and/or shape and then baked to form a fully baked or par-baked bread product. The bread product may then be topped with one or more toppings, if desired. The bread product and any toppings that have been added are then frozen.

As those skilled in the art will realize, the baking conditions will largely depend on the type of oven used and the size/weight of the dough. For example, a dough piece, for example, about 190 grams, in the shape of a square or circular could be baked in an impingement-type oven at about 700 to about 750° F. for about 1 to about 2 minutes. As one of ordinary skill in the art will readily recognize, the precise baking temperatures and baking time will vary depending on the type of oven used and the size and weight of bread product being made.

Bread products of conventional and non-conventional shapes can be formed. Such conventional shapes include, for example, a generally circular, oval square, rectangular (rectangular with one or more rounded ends), and the like, although other shapes may be prepared, if desired. The bread product generally has a thickness of less than about 10 mm, preferably about 1 to about 5 mm, more preferably about 2 to about 4 mm.

The raw dough may be directly used in baking operations or, alternatively, it may be stored under refrigerated or frozen conditions as a chilled product until used later. The dough may be topped to provide a composite dough product that can be subsequently baked. Depending on the product, the dough may be pre-shaped, baked or par-baked, and topped. The bread product and/or topped bread product may be packaged in any suitable conventional manner for storage and handling.

Preferably, the bread product is frozen after baking. The bread products described herein may be frozen for long term storage. Such bread products are stable at freezing temperatures for at least about 4 months, preferably at least about 6 months, and more preferably at least about 12 months.

If desired, the bread product may be provided with one or more toppings thereon. Generally, the topping is placed on the top of the flatbread using any suitable automatic, semiautomatic, or manual technique. Suitable toppings include, for example, meats (e.g., chicken, turkey, beef, ham, and the like), cheeses, fruits, vegetables, tofu, soy, soy derivatives, and the like as well as combinations thereof. Such toppings may also include sauces, dressings, pesto, spreads, gravies, condiments, spices, flavorings, colorants, and the like as well as combinations thereof. Preferably, meat and/or vegetables in the topping are in the form of lumps or diced shapes (generally less than about 2 mm in the longest dimension).

The meat may be in a shaved, sliced, shredded, chopped, or other convenient form. The type of meat that may be used is not particularly limited. The meat may be beef (e.g., roast beef, barbecued beef, steak, hamburger, etc.); poultry (e.g., chicken breast, barbecued chicken, turkey breast, turkey burger, chicken salad, etc.); pork (e.g., ham, barbecued pork, ham salad, Canadian bacon, etc.); and fish (e.g., tuna, tuna salad, lox, etc.). The meat topping also may be processed meats like bacon, sausage, bologna, olive loaf, pepperoni, salami, corned beef, pastrami, liverwurst, and so forth. Combinations of such meat products may be used if desired. Soy or soy derivative meat substitutes may be used as a protein source in combination with the meat filling, or alternatively in place thereof in the sandwich filling. The water content and water activity of the meat topping may vary greatly depending on the type of meat selected. For instance, leaner cuts of meat generally contain less water content than less lean cuts.

The type of cheese that may be used is not particularly limited. The cheese may be in form of shredded, sliced, shaved, flaked, powdered, crumbled, slabbed, creamed, and so forth; preferably, the cheese is in the form of cheese shreds. The cheese type, for example, may be process cheese, cheddar cheese, Swiss cheese, American cheese, Provolone cheese, mozzarella cheese, Parmesan cheese, blue cheese, Monterey Jack cheese, Romano cheese, cream cheese, Havarti cheese, Gouda cheese, Muenster cheese, Asiago cheese, feta cheese, Gorgonzola cheese, and combinations thereof. Of course, other cheeses may be used if desired.

Vegetables suitable for use in the filling include, for example, onions, tomato, mushrooms, spinach, bell peppers, hot peppers, garlic, bean sprouts, cucumber, zucchini, potato, kale, basil, and the like as well as combinations thereof. Of course, other vegetables may be used if desired.

Both the bread portion and the topping can be seasoned, such as with salt, pepper, oregano, red pepper flakes or spreads, onion powder, garlic powder, sesame seeds, poppy seeds, cinnamon, and the like as well as combinations thereof. Food additives, such as preservatives, flavorings, colors, emulsifiers, soy flour, and so forth, also can be included in or applied to the dough and/or topping.

All or some of the ingredients in the topping may be premixed if desired; alternatively, all or some of the ingredients may be individually placed on the bread product. All or some of the ingredients in the topping may be frozen or thawed when placed on the bread product. Indeed the entire topping may be prepared and then frozen into the appropriate size and shape (i.e., puck or other shape) and then placed frozen on the bread product. The bread product may also be pre-frozen. The bread product may be frozen before or after the addition of toppings, if used. Conventional freezing techniques are used to freeze the bread product.

The assembled bread product is packaged, preferably using modified atmosphere techniques, frozen (if not already frozen), and then stored under suitable conditions. In one aspect, the bread product is provided as a fully assembled flatbread with toppings thereon and contained in a package that can be opened and then heated directly in a conventional oven.

Alternatively, the frozen bread product and toppings can be provided in a single serve package having separate compartments or pouches for the frozen bread product and various toppings. The pouches preferably are sealed under an inert atmosphere to increase the shelf life of the product or kit.

The frozen bread products may be cooked in a conventional oven. Generally, the bread products can be baked in a conventional oven for about 18 to 22 minutes at about 375 to about 425° F. if the product is topped or for about 5 to about 10 minutes if untopped. As one of ordinary skill in the art will readily recognize, the precise cooking conditions will vary depending on the type of oven used and the type and thickness of bread product being made.

The examples that follow are intended to illustrate the invention and not to limit it. All percentages used herein are by weight unless otherwise indicated. All patents, patent applications, and literature references cited herein are hereby incorporated by reference in their entirety.

### EXAMPLES

A pizza dough was prepared using the following formulation:

| | Baker's |
|---|---|
| Ingredient | Percentages |
| Wheat flour (from ADM) | 100 |
| Compressed yeast (from Universal Foods) | 4.0 |
| Encapsulated sodium bicarbonate (from Balchem) | 0.9 |
| Sodium aluminum phosphate, acidic (from Rhodia, Inc.) | 0.9 |
| Salt | 2.0 |
| Fine granular sugar | 0.99 |
| Mono- and di-glycerides (64k) (from Caravan | 0.5 |
| Ingredients) | |
| Butter flavored shortening flakes (from Golden Brands) | 9.0 |
| Water | 58.0 |
| Olive oil (from Borges-National USA Corporation) | 4.0 |

All dough ingredients except for the butter flavored shortening flakes are added to a mixer and mixed on low for about 1 minute and then mixed on high speed for about 4 minutes. The butter flavored shortening flakes are then added and mixed on high for about 2 minutes. The dough is then transferred to a sheeter and sheeted to about 0.25 inch thickness. The sheeted dough is cute to form dough discs of about 200 g. The dough is proofed for 25 minutes at 100° F. (±10° F.) and RH 50±5 percent. The proofed dough is then pressed with 11.5″ dies. The press conditions are:

| | |
|---|---|
| Temperature | 225° F. top, ±10° F. |
| | 315° F. bottom, ±10° F. |
| Pressure | 900 psi ± 100 psi |
| Dwell time | 9 sec ± 1 sec |

The pressed dough is docked and transferred through the ovens for 90 seconds at a temperature of 750° F. The crusts have a crispy, medium golden-brown color on the bottom surface and a flaky interior.

While the invention has been particularly described with specific reference to particular process and product embodiments, it will be appreciated that various alterations, modifications, and adaptations may be based on the present disclosure, and are intended to be within the spirit and scope of the invention as defined by the following claims.

We claim:

1. A frozen, fully baked or par-baked, thin crust bread product having a top surface, a bottom surface, and an interior portion, and a thickness of about 1 to about 10 mm, the bread product prepared from a dough comprising, in baker's percentages, 100 percent flour having a protein content of less than about 12 percent, about 55 to about 70 percent water, about 0.25 to about 1.5 percent mono- and/or di-glycerides, about 0.5 to about 8 percent oil, about 0.5 to about 8 percent leavening agent, and about 4 to about 15 percent fat flakes,
wherein the fat flakes have a solid fat content of about 45 to about 65 percent at 80° F., a flake thickness less than the thickness of the baked bread product, and are distributed uniformly throughout the dough before baking or par-baking,
wherein the leavening agent comprises yeast, encapsulated chemical leavening base, and leavening acid, and
wherein the bread product has, after being heated from the frozen state to a temperature suitable for consumption in a conventional oven, (1) a crispy texture for the bottom surface, (2) a flaky texture for the interior portion, and (3) a thickness of less than 10 mm.

2. The bread product of claim 1, wherein the leavening agent comprises about 0.5 to about 5 percent yeast, 0.1 to about 2 percent encapsulated chemical leavening base, and 0.1 to about 1 percent leavening acid.

3. The bread product of claim 2, wherein the yeast is compressed yeast, the encapsulated chemical leavening base is sodium bicarbonate and the leavening acid is sodium aluminum phosphate.

4. The bread product of claim 1, wherein the bread product has a thickness of about 1 to about 5 mm.

5. The bread product of claim 1, wherein the bread product has a thickness of about 2 to about 4 mm.

6. The bread product of claim 5, wherein the fat flakes have a thickness of less than about 1.5 mm.

7. The bread product of claim 1, wherein the dough comprises, in baker's percentages, 100 percent flour, about 58 to about 60 percent water, about 5 to about 12 percent fat flakes, about 3 to about 5 percent oil, about 0.25 to about 1.0 percent mono- and/or di-glycerides, and wherein the leavening agent comprise about 0.5 to about 5 percent yeast, 0.1 to about 2 percent encapsulated chemical leavening base, and 0.1 to about 1 percent leavening acid.

8. The bread product of claim 1, wherein the flour has a protein content of about 9 to about 12 percent.

9. The bread product of claim 1, wherein the fat flakes have a solid fat content of about 50 to about 60 percent at 80° F.

10. The bread product of claim 1, wherein the fat flakes have a solid fat content of about 55 percent at 80° F.

11. A frozen, fully baked or par baked, thin crust pizza product having a top surface, a bottom surface, an interior portion, and a thickness of about 1 to about 10 mm, the thin crust pizza prepared from a dough comprising, in baker's percentages, 100 percent flour having a protein content of less than about 12 percent, about 55 to about 70 percent water, about 0.25 to about 1.5 percent mono- and/or di-glycerides, about 0.5 to about 8 percent oil, about 0.5 to about 8 percent leavening agent, and about 4 to about 15 percent fat flakes,
wherein the fat flakes have a solid fat content of about 45 to about 65 percent at 80° F., a flake thickness less than the thickness of the baked thin crust pizza product, and are distributed uniformly throughout the dough before baking or par-baking,
wherein the fully baked or par baked thin crust pizza product comprises at least one pizza topping and is suitable for heating in a conventional oven from a frozen state before consumption by a consumer, and
wherein the bread product has, after being heated from frozen state to a temperature suitable for consumption in a conventional oven, (1) a crispy texture for the bottom surface, (2) a flaky texture for the interior portion, and (3) a thickness of about 1 to about 10 mm.

12. The thin crust pizza product of claim 11, wherein the leavening agent comprises about 0.5 to about 5 percent yeast, 0.1 to about 2 percent encapsulated chemical leavening base, and 0.1 to about 1 percent leavening acid.

13. The thin crust pizza product of claim 12, wherein the yeast is compressed yeast, the encapsulated chemical leavening base is sodium bicarbonate and the leavening acid is sodium aluminum phosphate.

14. The thin crust pizza product of claim 11, wherein the bread product has a thickness of about 1 to about 5 mm.

15. The thin crust pizza product of claim 14, wherein the bread product has a thickness of about 2 to about 4 mm.

16. The thin crust pizza product of claim 15, wherein the fat flakes have a thickness of less than about 1.5 mm.

17. The thin crust pizza product of claim 11, wherein the flour has a protein content of about 9 to about 12 percent.

18. The thin crust pizza product of claim 11, wherein the fat flakes have a solid fat content of about 50 to about 60 percent at 80° F.

19. The thin crust pizza product of claim 11, wherein the fat flakes have a solid fat content of about 55 percent at 80° F.

20. The thin crust pizza product of claim 11, wherein the dough comprises, in baker's percentages, 100 percent flour, about 58 to about 60 percent water, about 5 to about 12 percent fat flakes, about 3 to about 5 percent oil, about 0.25 to about 1.0 percent mono- and/or di-glycerides, and wherein the leavening agent comprise about 0.5 to about 5 percent yeast, 0.1 to about 2 percent encapsulated chemical leavening base, and 0.1 to about 1 percent leavening acid.

21. A process for preparing a fully baked or par baked bread product having a thickness of about 1 to about 10 mm, the method comprising:
mixing, in baker's percentages, 100 percent flour having a protein content of less than about 12 percent, about 55 to about 70 percent water, about 0.25 to about 1.5 percent mono- and/or di-glycerides, about 0.5 to about 8 percent oil, and about 0.5 to about 8 percent leavening agent, to form a first dough mixture;
adding about 4 to about 15 percent fat flakes agent to the first dough mixture and mixing in a manner effective to provide a dough with fat flakes of desired dimensions distributed uniformly throughout the dough, the fat flakes having a solid fat content of about 45 to about 65 percent at 80° F., wherein the desired dimensions include a flake thickness less than the thickness of the baked bread product;
resting the dough;
proofing the dough;
shaping the dough into a desired shape for the bread product;
baking the dough to form a fully baked or par baked bread product;
freezing the baked bread product, wherein the frozen baked bread product is suitable for heating in an oven before consumption by a consumer to provide a bread product having (1) a crispy texture for the bottom surface, (2) a flaky texture for the interior portion, and (3) a thickness of about 1 to about 10 mm.

22. The process of claim 21, wherein the method further comprises topping the baked bread product with at least one pizza topping.

23. The process of claim 21, wherein the leavening agent comprises about 0.5 to about 5 percent yeast, 0.1 to about 2 percent encapsulated chemical leavening base, and 0.1 to about 1 percent leavening acid.

24. The process of claim 21, wherein the bread product is a pizza crust.

25. The process of claim 21, wherein the bread product has a thickness of about 1 to about 5 mm.

26. The process of claim 21, wherein the bread product has a thickness of about 2 to about 4 mm.

27. The process of claim 26, wherein the fat flakes have a thickness of less than about 1.5 mm.

28. The process of claim 21, wherein the fat flakes have a solid fat content of about 50 to about 60 percent at 80° F.

29. The process of claim 21, wherein the fat flakes have a solid fat content of about 55 percent at 80° F.

30. The process of claim 21, wherein the flour has a protein content of about 9 to about 12 percent.

31. The process of claim 21, wherein the dough comprises, in baker's percentages, 100 percent flour, about 58 to about 60 percent water, about 5 to about 12 percent fat flakes, about 3 to about 5 percent oil, about 0.25 to about 1.0 percent mono- and/or di-glycerides, and wherein the leavening agent comprise about 0.5 to about 5 percent yeast, 0.1 to about 2 percent encapsulated chemical leavening base, and 0.1 to about 1 percent leavening acid.
